(19) United States
(12) Patent Application Publication
(10) Pub. No.: US 2020/0090284 A1
(43) Pub. Date: Mar. 19, 2020

(54) SOCIALLY-ENABLED MOTIVATIONAL PREDISPOSITION PREDICTION

(71) Applicant: International Business Machines Corporation, Armonk, NY (US)

(72) Inventors: Kelley Anders, East New Market, MD (US); Gregory J. Boss, Saginaw, MI (US); Jeremy R. Fox, Georgetown, TX (US); Sarbajit K. Rakshit, Kolkata (IN)

(21) Appl. No.: 16/131,771

(22) Filed: Sep. 14, 2018

(51) Int. Cl. G06Q 50/00; G06N 7/00

(52) U.S. Cl. CPC G06Q 50/01; G06N 7/005

(57) ABSTRACT

The method, computer program product and computer system may include a computing device which may collect user data for an identified user across one or more social media platforms and determine a user sentiment to one or more topics. The computing device may determine a probability of the identified user's positive response to positive or negative feedback to the one or more topics based on the determined user sentiment. The computing device may generate a visual model illustrating the probability of the user's positive response and provide one or more motivational recommendations to motivate the user. The computing device may determine that not enough user data has been collected and generate a message to a user based on the one or more topics within the collected user data to solicit an interaction from the user.

### BACKGROUND

The present invention relates generally to a method, system, and computer program for predicting the motivational predisposition of an individual. More particularly, the present invention relates to a method, system, and computer program for predicting the motivational predisposition of an individual for a particular topic through analysis of an individual's social media data.

Motivation is the driving force behind almost all human activity. Individuals must be motivated to accomplish something otherwise they would not do it. However, individuals are motivated by different kinds of written and/or verbal feedback, which may vary from situation to situation. For example, an employee may be perceived as doing the minimum amount of work required at a certain level. The manager of this employee would want to motivate the employee to achieve more, but without extensive prior experience with the employee, the manager may not know how to best motivate the employee to accomplish more. The employee may respond best to negative feedback in which the manager coaches them on what they need to do differently. Conversely, the employee may respond best to positive feedback such as the manager providing some type of incentive or reward for increased performance. Further, the employee may respond differently in another situation. For instance, the employee may be having a conflict with another employee and while the employee responded best to positive feedback regarding his/her performance, the employee may respond best to negative feedback regarding the employee conflict. The same variations in motivational responses are present throughout society and are unique to every individual. Therefore, absent an extensive and often personal relationship with someone, it almost impossible to know how to best motivate that unique individual to accomplish something.

### BRIEF SUMMARY

An embodiment of the invention may include a method, computer program product and computer system for predicting the motivational predisposition of an individual. The method, computer program product and computer system may include computing device which may collect user data for an identified user across one or more social media platforms and determine a user sentiment for the identified user to one or more topics within the collected user data. The computing device may determine, a probability of the identified user's positive response to positive or negative feedback to the one or more topics based on the determined user sentiment. The computing device may generate a visual model illustrating the probability of the user's positive response and provide one or more motivational recommendations to motivate the user based on the determined probability of the user's positive response to positive or negative feedback to the one or more topics based on the determined user sentiment. The computing device determine that not enough user data has been collected to analyze generate a message to a user based on the one or more topics within the collected user data to solicit an interaction from the user.

### BRIEF DESCRIPTION OF THE DRAWINGS

FIG. 1a illustrates a system for motivation prediction, in accordance with an embodiment of the invention.

FIG. 1b illustrates example operating modules of the motivation prediction system of FIG. 1a;

FIG. 2 is a flowchart illustrating an example method of the motivation prediction, in accordance with an embodiment of the invention.

FIG. 3 is a flowchart illustrating an example method of the motivation prediction, in accordance with an embodiment of the invention.

FIG. 4 is a block diagram depicting the hardware components of the motivation prediction system of FIG. 1, in accordance with an embodiment of the invention.

FIG. 5 illustrates a cloud computing environment, in accordance with an embodiment of the invention.

FIG. 6 illustrates a set of functional abstraction layers provided by the cloud computing environment of FIG. 5, in accordance with an embodiment of the invention.

### DETAILED DESCRIPTION

Embodiments of the present invention will now be described in detail with reference to the accompanying Figures.

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention provides a method, computer program, and computer system for predicting the motivational predisposition of an individual for a particular topic through analysis of an individual's social media data. Current technology does not allow for the collection and analysis of social media data to enable the modeling of motivational behaviors unique to an individual. Further, current technology fails to allow a user to determine what type of motivational force, such as, but not limited to, positive feedback and negative feedback, to use to best motivate an individual in a particular situation. The present invention improves current technology by enabling the determination of which type of motivation an individual has a proclivity, i.e. predisposition, towards based on the individual's social engagement per topic. The present invention also allows for the determination of the probability of a positive motivational reaction for an individual given a certain type of feedback per topic. Further, the present invention allows for the broadening the amount of data available to analyze the motivation predisposition of an individual by tailoring specific messages to that individual to respond to on social media platforms.

The present invention improves existing question/answer (QA) systems by adding the corpus of data used by the QA system. An example of a QA system may be the IBM Watson™ QA system available from International Business Machines Corporation of Armonk, N.Y., which is augmented with the mechanisms of the illustrative embodiments of the present invention described hereafter. The QA system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity. The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question. The data collected, analyzed, and generated by the present invention, as described herein, may be added to the corpus of data of a QA system. Thus, the collected, analyzed, and generated by the present invention may be utilized by the QA system to generate an answer to a question. For example, a user might input a question regarding worker motivation in response to feedback and the QA system may utilize the data of the present invention to formulate an answer.

Reference will now be made in detail to the embodiments of the present invention, examples of which are illustrated in the accompanying drawings, wherein like reference numerals refer to like elements throughout. Embodiments of the invention are generally directed to a system for predicting the motivational predisposition of an individual.

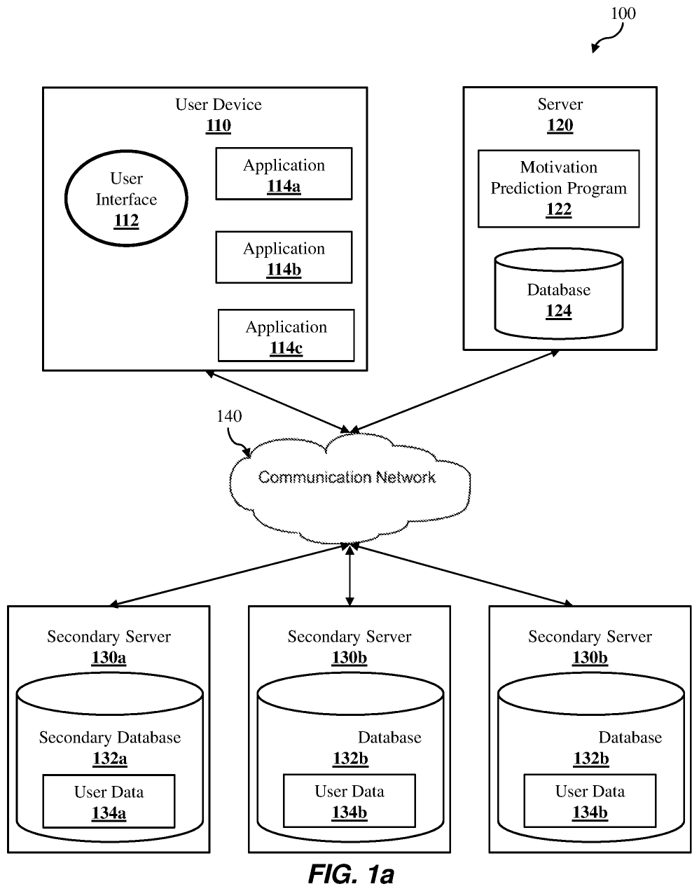

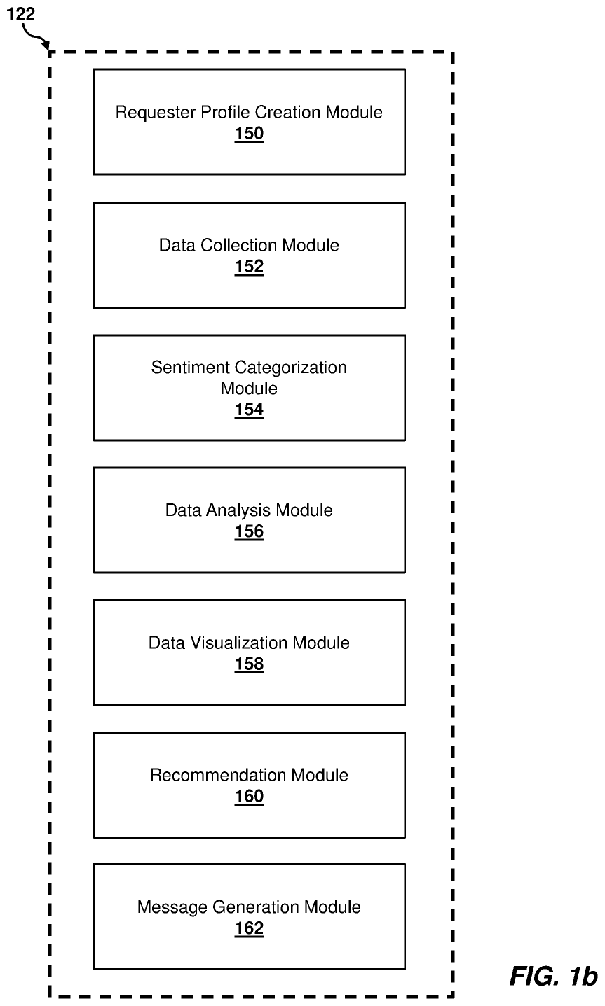

FIG. 1 illustrates a motivation prediction system 100, in accordance with an embodiment of the invention. In an example embodiment, motivation prediction system 100 includes a user device 110, a server 120, and secondary servers 130a-c, interconnected via network 140.

In the example embodiment, the network 140 is the Internet, representing a worldwide collection of networks and gateways to support communications between devices connected to the Internet. The network 140 may include, for example, wired, wireless or fiber optic connections. In other embodiments, the network 140 may be implemented as an intranet, a local area network (LAN), or a wide area network (WAN). In general, the network 140 can be any combination of connections and protocols that will support communications between the user device 110, the server 120, and the secondary servers 130a, 130b, 130c.

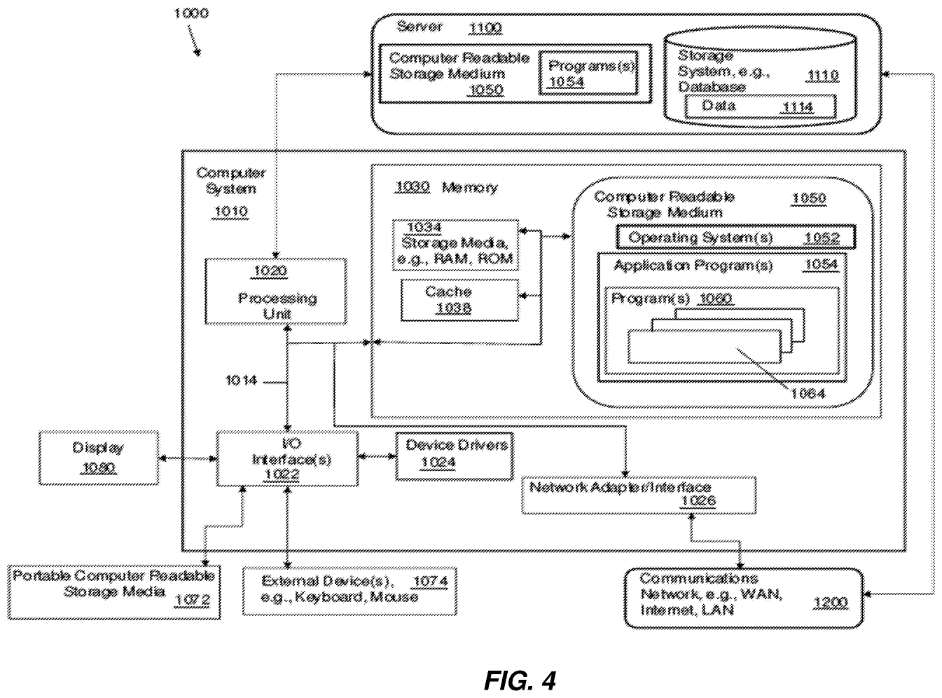

The user device 110 may include a user interface 112, and applications 114a, 114b, 114c. In the example embodiment, the user device 110 may be a desktop computer, a notebook, a laptop computer, a tablet computer, a thin client, or any other electronic device or computing system capable of storing compiling and organizing audio, visual, or textual content and receiving and sending that content to and from other computing devices, such as the server 120, and the secondary servers 130a, 130b, 130c via the network 140. While only a single user device 110 is depicted, it can be appreciated that any number of user devices may be part of the motivation prediction system 100. In some embodiments, the user device 110 includes a collection of devices or data sources. The user device 110 is described in more detail with reference to FIG. 4.

The user interface 112 includes components used to receive input from a user on the user device 110 and transmit the input to the motivation prediction program 122 residing on server 120, or conversely to receive information from the motivation prediction program 122 and display the information to the user on user device 110. In an example embodiment, the user interface 112 uses a combination of technologies and devices, such as device drivers, to provide a platform to enable users of the user device 110 to interact with the motivation prediction program 122. In the example embodiment, the user interface 112 receives input, such as but not limited to, textual, visual, or audio input received from a physical input device, such as but not limited to, a keypad and/or a microphone.

The applications 114a, 114b, 114c may be any computer application which has information relating to a user's online engagement and presence such as, but not limited to, social media applications, email applications, and instant messaging applications, etc. Examples of such applications 114a, 114b, 114c may be Twitter®, Facebook®, Snapchat®, Instagram®, LinkedIn®, IBM® Connections, Microsoft Outlook®, Gmail®, Lotus Notes®, Amazon® Alexa®, etc. While three applications 114a, 114b, 114c are illustrated, it can be appreciated that any number of applications may be part of the motivation prediction system 100 including less than three or more than three depending on the user. The data associated with applications 114a, 114b, 114c may be stored on secondary servers 130a, 130b, 130c associated with the application 114a, 114b, 114c, respectively. For example, a user on user device 110 may have Facebook®, Twitter®, and Gmail® accounts, i.e. applications 114a, 114b, 114c, and the data associated with each application 114a, 114b, 114c would be stored on the Facebook, Twitter, and Gmail® servers, i.e., secondary servers 130a, 130b, 130c.

The secondary servers 130a, 130b, 130c may include secondary databases 132a, 132b, 132c and user data 134a, 134b, 134c. While three secondary servers 130a, 130b, 130c are illustrated, it can be appreciated that any number of secondary servers 130 may be part of the motivation prediction system 100 including less than three or more than three depending on the user. In the example embodiment, the secondary servers 130a, 130b, 130c may be a desktop computer, a notebook, a laptop computer, a tablet computer, a thin client, or any other electronic device or computing system capable of storing compiling and organizing audio, visual, or textual content and receiving and sending that content to and from other computing devices, such as the user device 110, and the server 120 via the network 140. In some embodiments, the secondary servers 130a, 130b, 130c include a collection of devices or data sources. The secondary servers 130a, 130b, 130c are described in more detail with reference to FIG. 4.

The secondary databases 132a, 132b, 132c may be a collection of the user data 134a, 134b, 134c. The user data 134a, 134b, 134c may be a user's and the user's connections' online social engagement, e.g. online conversation, data including, but not limited to, audio, visual, and textual files. For example, the user data 134a, 134b, 134c may include, but is not limited to, social media feed posts, online messages, emails, tweets, conversation history, oral commands etc. of the user and any of the user's connections on applications 114a, 114b, 114c. The user data 134a, 134b, 134c may also include, but is not limited to, the user's and the user's connections' interactions with the applications 114a, 114b, 114c. For example, the user data 134a, 134b, 134c may include, but it not limited to, how and to which posts the user or the user's connections respond to on Facebook®, how and to which tweets the user or the user's connections respond to on Twitter®, etc. The user's connections may be, but is not limited to, friends on Facebook®, followers and accounts followed on Twitter®, followers and accounts followed on Snapchat®, correspondents on Gmail®, etc. The user data 134a, 134b, 134c stored in secondary databases 132a, 132b, 132c located on the secondary servers 130a, 130b, 130c can be accessed through using the network 140.

The server 120 includes motivation prediction program 122 and database 124. In the example embodiment, the server 120 may be a desktop computer, a notebook, a laptop computer, a tablet computer, a thin client, or any other electronic device or computing system capable of storing compiling and organizing audio, visual, or textual content and receiving and sending that content to and from other computing devices, such as the user device 110 and the secondary servers 130a, 130b, 130c via network 140. The server 120 is described in more detail with reference to FIG. 4.

The motivation prediction program 122 is a program capable of collecting data from a user's interactions and engagement with applications 114a, 114b, 114c and determining which type of motivation a user has a proclivity toward based on the user's online social engagement on a topical basis. For example, the motivation prediction program 122 may determine whether a user responds more towards negative feedback versus positive feedback in certain situations and vice versa in other situations. The motivation prediction program 122 may then suggest the best motivational means for a user given a certain situation. The motivation prediction program 122 is described in more detail with reference to FIG. 1b.

The database 124 may store motivational prediction data associated with a user of the device 110 obtained from processing the data stored on the secondary servers 130a, 130b, 130c by the motivation prediction program 122.

FIG. 1b illustrates example modules of the motivation prediction program 122. In an example embodiment, the motivation prediction program 122 may include seven modules: requester profile creation module 150, data collection module 152, word sentiment categorization module 154, data analysis module 156, data visualization module 158, recommendation module 160, and message generation module 162.

The requester profile creation module 150 receives input from a user of user device 110, hereinafter referred to as the requester, to create a requester profile. The requester input may include, but is not limited to, the requester's name, the requester's account information for applications 114a, 114b, 114c, and the names of the people, hereinafter requester contacts, whose online presence and engagement the requester wants the motivation prediction program 122 to analyze. For example, the requester may be a manager at Company X with ten employees the requester is responsible for managing. The requester may create a profile on motivation prediction program 122 via the user interface 112 on the user device 110. Thus, the requester's profile may include the requester's name, the requester's social media accounts login information, and the names of the ten employees the requester is responsible for managing, i.e. the requester's contacts (also referred to herein as “users”). While embodiments are described herein with an example of a requester being a manager and members of the manager's staff, it will be appreciated that various other persons and entities may be a requester or a user without departing from the spirit and scope of the invention. In one alternative, a requester may by a software application. In another alternative, an individual may make a request with respect to him or herself, i.e., an individual may be both a requester and a user.

The data collection module 152 receives the user data 134a, 134b, 134c associated with the requester's contacts identified in the requester profile from the secondary servers 130a, 130b, 130c associated with the applications 114a, 114b, 114c for processing. Continuing with the above example, the data collection module 152 may receive the user data 134a, 134b, 134c of the requester's ten employees. In an alternative embodiment, the user data 134a, 134b, 134c may be collected from the secondary servers 130a, 130b, 130c associated with the applications 114a, 114b, 114c and stored in database 124 and the data collection module 152 receives the user data 134a, 134b. 134c from the database 124.

The sentiment categorization module 154 determines the sentiment expressed by the requester's contact to one or more topics within the received user data 134a, 134b, 134c. The sentiment categorization module 154 may determine the sentiment expressed by the requester's contact to one or more topics within the received user data 134a, 134b, 134c using natural language processing (NLP) techniques. NLP techniques enable computers to derive meaning from human or natural language input, such as but not limited to, the received user data 134a, 134b, 134c. Utilizing NLP, large chunks of text are analyzed, segmented, summarized, and/or translated in order to alleviate and expedite a user's identification of relevant information. Thus, the sentiment categorization module 154 determines, according to the topic contained within the received user data 134a, 134b, 134c, the sentiment expressed by the received user data 134a, 134b, 134c for each topic. For example, the sentiment categorization module 154 may analyze the received user data 134a, 134b, 134c of an employee, i.e. requester's contact, identified in the requester profile of the requester. The sentiment categorization module 154 may parse the received user data 134a, 134b, 134c of the identified employee, identifying several topics such as, but not limited to, health, relationships, family, education, work, school, etc. and what sentiment the identified employee expressed for each identified topic. The sentiment expressed for each topic may be derived from the received user data 134a, 134b, 134c by analyzing how the requester's contact associated with the received user data 134a, 134b, 134c responded to the identified topic. For example, the received user data 134a, 134b, 134c may include, but is not limited to, the employee's Facebook® “likes”, “dislikes”, “sad”, “laughing”, “angry”, and “surprised” reactions and the employee's response tweets and retweets on Twitter®, etc. Therefore, the sentiment categorization module 154 will determine an employee has a positive sentiment towards cooking and health if, for example, the received user data 134a, 134b, 134c associated with contains an employee's “like” of a Facebook® post of an article of healthy food recipes.

The data analysis module 156 determines one or more probabilities of how the user associated with the received user data 134a, 134b, 134c will respond to positive or negative feedback from the requester or another person or entity with respect to feedback on a particular topic. The data analysis module 216 may analyze the received user data 134a, 134b, 134c using one or more models such as but not limited to, a latent class model, and a regression model. The data analysis module 156 may determine correlations between topics, and topic authors or sources, on the one hand, and determined expressions of sentiment. Thus, the data analysis module 156 determines a crowd-sourced baseline of motivational behaviors from the received user data 134a, 134b, 134c for a user associated with the received user data 134a, 134b, 134c. The data analysis module 156 may determine probabilities for how an employee of the requester reacts towards a particular topic, source, author, or person. For example, the data analysis module 156 may determine a baseline for how an employee of the requester reacts towards a particular topic. In another example, the user data 134a, 134b, 134c may be for a child and the requester could be, for example, a parent, teacher, and/or a coach and the child the data analysis module 156 may determine that the child responds to negative feedback from a parent and only responds to positive feedback from a teacher and/or coach.

The data visualization module 158 generates a visual model illustrating the probability of how the user associated with the received user data 134a, 134b, 134c will respond to positive or negative feedback from the requester. The data visualization module 158 may generate a display of the illustrated probabilities, i.e., the crowd-sourced baselines of motivational behavior per topic, via the user interface 112 on user computer 110. For example, the data visualization module 158 may present to the requester a graph of motivational behaviors for a requested user based on the user data 134a, 134b, 134c indicating how that requested user will react towards positive or negative feedback given a certain topic. The data visualization module 158 may indicate topics to which a requested user will respond to negative feedback in red and topics to which a requested user will respond to positive feedback in green. Further, the data visualization module 158 may visualize the probabilities that requested user will respond to negative feedback or positive feedback for particular topics. The data visualization module 158 may for example indicate a higher probability with a darker color or with a higher bar graph. In another example, the data visualization module 158 may present to the requester a trendline of motivational behaviors for a requested user based on the user data 134a, 134b, 134c indicating how that requested user will react towards positive or negative feedback given a certain topic. In one alternative, the probability of how the user associated with the received user data 134a, 134b, 134c will respond to positive or negative feedback from the requester is provided in a data file to a requesting application program.

The recommendation module 160 provides the requester with a recommended type of feedback to use to motivate the requested user associated with the received user data 134a, 134b, 134c. The feedback may include, but is not limited to, tasks, items, and activities that will motivate the user. In one alternative, the recommended type of feedback to use to motivate the requested user is provided in a data file to a requesting application program. The recommendation module 160 may provide the requester with a recommendation via user interface 112 on user device 110. Further, the recommendation module 160 may provide the requester with a recommendation in conjunction with the illustrated probabilities created by the data visualization module 158. Alternatively, the recommendation module 160 may incorporate the probability determined by the data analysis module 156 and data visualization module 158 into the recommendation. For example, the recommendation module 160 may provide a manager, i.e. the requester, with a recommendation to conduct a performance review with an employee in which the employee's strengths are highlighted, i.e. positive feedback. In addition, the recommendation module 160 may provide the manager with the probability that a positive performance review will motivate that employee to do better. Conversely, if the data analysis module 156 and the data visualization module 158 determine that an employee will respond better to negative feedback, the recommendation module 160 may recommend that the manager conduct a performance review in which the employee's shortfalls are discussed.

The message generation module 162 generates a message to be sent to a user on applications 114a, 114b, 114c. The post generation module 162 generates a message to be sent to a requester contact on applications 114a, 114b, 114c via secondary servers 130a, 130b, 130c when the motivation prediction program 122 does not have enough of the user data 134a, 134b, 134c to analyze. Thus, the message generation module 162 generates a message to which the requester contact can interact with to generate more data points for the motivation prediction program 122 to use. For example, the message generation module 162 may generate a Facebook® post which can then be posted to the requester contact's Facebook® feed. Once the user interacts, e.g. “likes” or “dislikes”, with that generated Facebook® post, the motivation prediction program 122 will have another data point within the user data 134a, 134b, 134c to analyze for that requester contact.

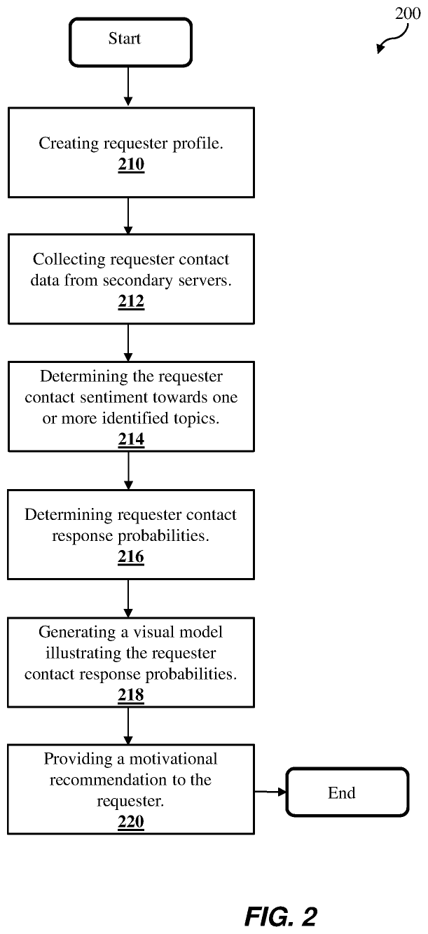

Referring to FIG. 2, a method 200 for motivation prediction is depicted, in accordance with an embodiment of the present invention.

Referring to block 210, a requester profile is created on the requester profile creation module 150 of motivation prediction program 122. Requester profile creation is described in more detail above with reference to the requester profile creation module 150.

Referring to block 212, the data collection module 152 of motivation prediction program 122 collects the user data 134a, 134b, 134c associated with the requester's contacts. Collection of the user data 134a, 134b, 134c is described in more detail above with reference to the data collection module 152.

Referring to block 214, the sentiment categorization module 154 determines the sentiment expressed by the requester's contact to one or more topics within the received user data 134a, 134b, 134c. Sentiment categorization is described in more detail above with reference to the sentiment categorization module 154.

Referring to block 216, the data analysis module 156 determines the probability of how the requester's contacts associated with the received user data 134a, 134b, 134c will respond to positive or negative feedback for a particular topic from the requester. Data analysis is described in more detail above with reference to the data analysis module 156.

Referring to block 218, the data visualization module 158 generates a visual model illustrating the probability of how the requester's contacts associated with the received user data 134a, 134b, 134c will respond to positive or negative feedback from the requester. Data visualization is described in more detail above with reference to the data visualization module 158.

Referring to block 220, the recommendation module 160 provides the requester with a recommended type of feedback to use to motivate the requester's contacts associated with the received user data 134a, 134b, 134c. Motivation recommendation is described in more detail above with reference to the recommendation module 160.

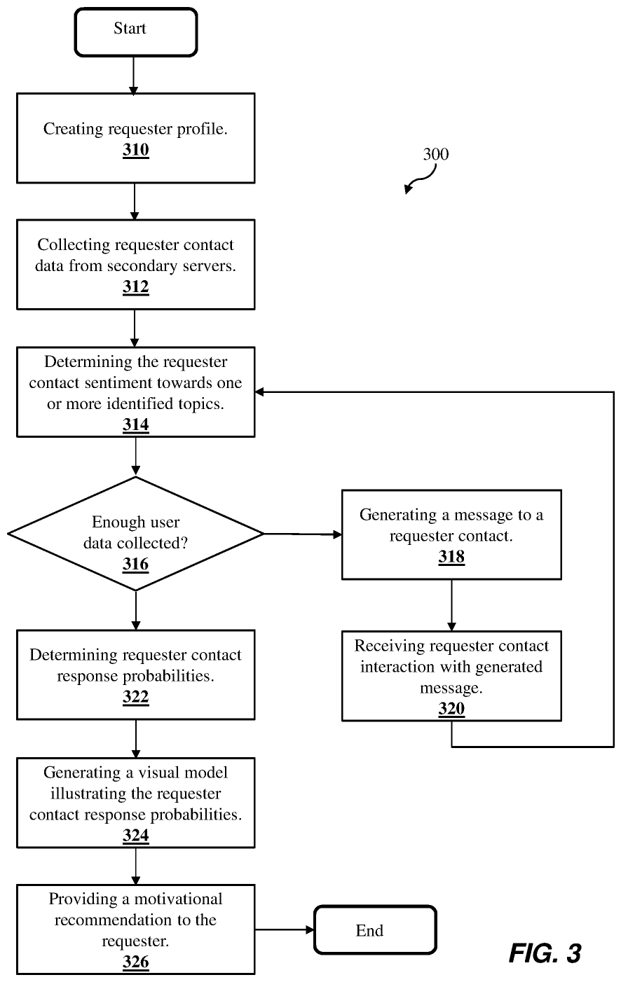

Referring to FIG. 3, another example method 300 for motivation prediction is depicted, in accordance with an embodiment of the present invention. The embodiment of FIG. 3 is substantially similar to that of FIG. 2 with blocks 310-314 being the same as blocks 210-214, blocks 322-326 being the same as blocks 216-220, and blocks 316-320 being new. The embodiment illustrated by method 300 allows for motivation prediction program 122 to generate messages and collect more user data 134a, 134b, 134c. The embodiment of FIG. 3 may be understood with reference to FIG. 2.

Referring to block 316, the motivation prediction program 122 determines if the data collection module 152 collected enough of the user data 134a, 134b, 134c to proceed to block 322. In response to the motivation prediction program 122 determining that the data collection module 152 did not collect enough of the user data 134a, 134b, 134c, the motivation prediction program 122 proceeds to block 318. In response to the motivation prediction program 122 determining that the data collection module 152 did collect enough of the user data 134a, 134b, 134c, the motivation prediction program 122 proceeds to blocks 322-326.

Referring to block 318, the message generation module 162 generates a message to be sent to a requester contact on applications 114a, 114b, 114c via secondary servers 130a, 130b, 130c. Message generation is described in more detail above with reference to the message generation module 162.

Referring to block 320, the motivation prediction program 122 receives updated user data 134a, 134b, 134c, when the requester contact responds, i.e. interacts, with the message generated and sent by the message generation module 162. Following block 320, the motivation prediction program 122 repeats blocks 314-320 until the motivation prediction program 122 determines that enough of the user data 134a, 134b, 134c has been collected. Once the motivation prediction program 122 determines that enough of the user data 134a, 134b, 134c has been collected, the motivation prediction program 122 proceeds to blocks 322-324.

Referring to FIG. 4, a system 1000 includes a computer system or computer 1010 shown in the form of a generic computing device. The methods 200 and 300 for example, may be embodied in a program(s) 1060 (FIG. 4) embodied on a computer readable storage device, for example, generally referred to as memory 1030 and more specifically, computer readable storage medium 1050 as shown in FIG. 4. For example, memory 1030 can include storage media 1034 such as RAM (Random Access Memory) or ROM (Read Only Memory), and cache memory 1038. The program 1060 is executable by the processing unit or processor 1020 of the computer system 1010 (to execute program steps, code, or program code). Additional data storage may also be embodied as a database 1110 which can include data 1114. The computer system 1010 and the program 1060 shown in FIG. 4 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 4 as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 4, the system 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media 1034 in the form of volatile memory, such as random access memory (RAM), and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The methods 200 and 300 (FIGS. 2-3), for example, may be embodied in one or more computer programs, generically referred to as a program(s) 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

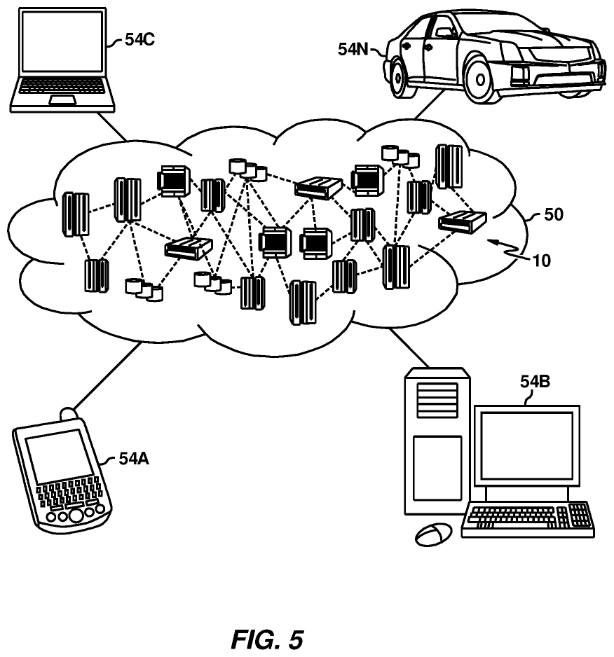

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

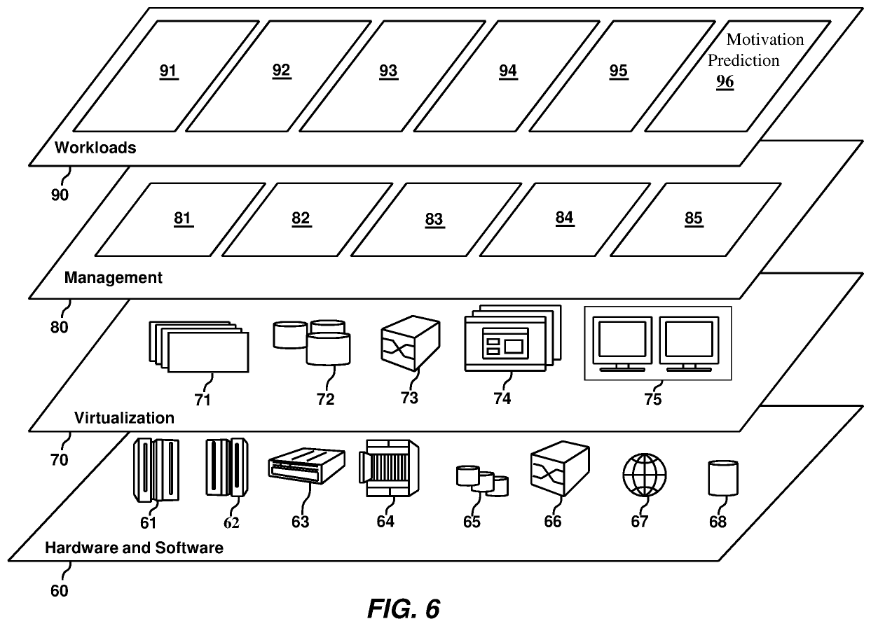

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and motivation prediction 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A method for predicting the motivational predisposition of an individual, the method comprising:
collecting, by a computing device, user data for an identified user across one or more social media platforms;
determining, by the computing device, a user sentiment for the identified user to one or more topics within the collected user data; and
determining, by the computing device, one or more probabilities of the identified user's positive response to positive or negative feedback to the one or more topics based on the determined user sentiment.

2. A method as in claim 1, further comprising:
generating, by the computing device, a visual model illustrating the one or more probabilities of the user's positive response.

3. A method as in claim 1, further comprising:
providing, by the computing device, one or more motivational recommendations to motivate the user based on the determined one or more probabilities of the user's positive response to positive or negative feedback to the one or more topics based on the determined user sentiment.

4. A method as in claim 1, further comprising:
determining, by the computing device, in response to collecting user data across one or more social media platforms that not enough data has been collected to analyze; and
generating, by the computing device, a message to a user based on the one or more topics within the collected user data, wherein the message solicits an interaction from the user.

5. A method as in claim 1, wherein the user data comprises user engagement on the one or more social media platforms.

6. A method as in claim 1, wherein the user sentiment is determined based on the user's interaction with online conversations on the one or more social media platforms.

7. A method as in claim 1, wherein determining, by the computing device, the one or more probabilities of the user's positive response to positive or negative feedback to the one or more topics based on the determined user sentiment further comprises:
generating, by the computing device, a probability model, the probability model consisting of at least one of a latent class model and a regression model.

8. A computer program product for predicting the motivational predisposition of an individual, the computer program product comprising:
a computer-readable storage medium having program instructions embodied therewith, wherein the computer readable storage medium is not a transitory signal per se, the program instructions executable by a computer to cause the computer to perform a method, comprising:
collecting, by a computing device, user data for an identified user across one or more social media platforms;
determining, by the computing device, a user sentiment for the identified user to one or more topics within the collected user data; and
determining, by the computing device, one or more probabilities of the identified user's positive response to positive or negative feedback to the one or more topics based on the determined user sentiment.

9. A computer program product as in claim 8, further comprising program instruction to:
generate, by the computing device, a visual model illustrating the one or more probabilities of the user's positive response.

10. A computer program product as in claim 8, further comprising program instruction to:
provide, by the computing device, one or more motivational recommendations to motivate the user based on the determined one or more probabilities of the user's positive response to positive or negative feedback to the one or more topics based on the determined user sentiment.

11. A computer program product as in claim 8, further comprising program instruction to:
determine, by the computing device, in response to collecting user data across one or more social media platforms that not enough data has been collected to analyze; and
generate, by the computing device, a message to a user based on the one or more topics within the collected user data, wherein the message solicits an interaction from the user.

12. A computer program product as in claim 8, wherein the user data comprises user engagement on the one or more social media platforms.

13. A computer program product as in claim 8, wherein the user sentiment is determined based on the user's interaction with online conversations on the one or more social media platforms.

14. A computer program product as in claim 8, wherein determining, by the computing device, the one or more probabilities of the user's positive response to positive or negative feedback to the one or more topics based on the determined user sentiment further comprises program instruction to:
generate, by the computing device, a probability model, the probability model consisting of at least one of a latent class model and a regression model.

15. A system for predicting the motivational predisposition of an individual, the system comprising:
a computer system comprising, a processor, a computer readable storage medium, and program instructions stored on the computer readable storage medium being executable by the processor to cause the computer system to:
collect, by a computing device, user data for an identified user across one or more social media platforms;
determine, by the computing device, a user sentiment for the identified user to one or more topics within the collected user data; and
determine, by the computing device, one or more probabilities of the identified user's positive response to positive or negative feedback to the one or more topics based on the determined user sentiment.

16. A system as in claim 15, further comprising program instruction to:
generate, by the computing device, a visual model illustrating the one or more probabilities of the user's positive response.

17. A system as in claim 15, further comprising program instruction to:
provide, by the computing device, one or more motivational recommendations to motivate the user based on the determined one or more probabilities of the user's positive response to positive or negative feedback to the one or more topics based on the determined user sentiment.

18. A system as in claim 15, further comprising program instruction to:
determine, by the computing device, in response to collecting user data across one or more social media platforms that not enough data has been collected to analyze; and
generate, by the computing device, a message to a user based on the one or more topics within the collected user data, wherein the message solicits an interaction from the user.

19. A system as in claim 15, wherein the user data comprises user engagement on the one or more social media platforms.

20. A system as in claim 15, wherein the user sentiment is determined based on the user's interaction with online conversations on the one or more social media platforms.
